(19) United States
(12) Patent Application Publication
(10) Pub. No.: US 2025/0373514 A1
(43) Pub. Date: Dec. 4, 2025

(54) TRANSMISSION AND RECEPTION METHODS AND APPARATUSES

(71) Applicant: FUJITSU LIMITED, Kawasaki-shi (JP)

(72) Inventors: Yujia SHAN, Beijing (CN); Xin WANG, Beijing (CN); Meiyi JIA, Beijing (CN)

(73) Assignee: FUJITSU LIMITED, Kawasaki-shi (JP)

(21) Appl. No.: 19/301,105

(22) Filed: Aug. 15, 2025

Related U.S. Application Data
(63) Continuation of application No. PCT/CN2023/076600, filed on Feb. 16, 2023.

(51) Int. Cl. H04L 41/16; H04W 8/22; H04W 24/02

(52) U.S. Cl. CPC H04L 41/16; H04W 8/22; H04W 24/02

(57) ABSTRACT

Model transmission and reception methods and an apparatus. The method includes: a network device transmitting configuration information to a terminal equipment, the configuration information being used for configuring or indicating the terminal equipment to receive partial data blocks of a model; and the network device transmitting the partial data blocks of the model to the terminal equipment.

### CROSS-REFERENCE TO RELATED APPLICATION

This application is a continuation application under 35 U.S.C. 111(a) of International Patent Application PCT/CN2023/076600 filed on Feb. 16, 2023, and designated the U.S., the entire contents of which are incorporated herein by reference.

### TECHNICAL FIELD

The present application relates to communication technical field.

### BACKGROUND

In recent years, artificial intelligence technology (AI/ML) represented by deep learning has developed rapidly and has been applied in multiple research and commercial fields due to its powerful nonlinear problem fitting ability. Similarly, the performance of artificial intelligence in various wireless communication applications has also been significantly improved compared with traditional methods. In the 3GPP standard discussion of RELEASE 18, three applications, i.e., Channel State Information (CSI) feedback, beam management, and wireless positioning, of artificial intelligence in wireless communication have been preliminarily determined. In future discussions, introduction of more wireless communication applications that use artificial intelligence technology is not excluded.

Although the application of artificial intelligence in wireless communication may bring many benefits, such as reducing beam management resource overhead and improving wireless positioning accuracy, it also introduces some unique problems of artificial intelligence technology. One of the issues is the transmission of artificial intelligence models between wireless communication entities.

Generally speaking, the current main artificial intelligence technology is deep learning, and in deep learning, a model file (referred to as a model) is obtained after data training, and the model file stores neural network structure of a deep learning model and the weight parameters between the nodes in the network.

The application of this neural network model in wireless communication will generally face the following problems:

For example, since the neural network is “deep”, in order to achieve better nonlinear fitting ability, the number of layers and the number of neurons (nodes) required for each layer of the model are both not too small. The direct consequence resulting from this is that the storage space requirement of the model is relatively large, typically between 10-100 MB.

For example, due to the particularity of the wireless communication network, in some necessary cases, the model needs to be transmitted between various entities such as user equipment (UE), a base station (gNB), a location management function (LMF) entity, an access and mobility management function (AMF) entity, and etc., and transmission must ensure certain quality requirements, such as integrity, timeliness, etc. If these requirements are not able to be met, it leads to a significant decline in the performance of the artificial intelligence model in a certain application, and may even fail to meet the minimum requirements of a certain application, forcing the abandonment of the use of artificial intelligence algorithms.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

However, the inventor finds that the wireless interface transmission supported in the current 3GPP protocol is difficult to meet the requirements of AI/ML model transmission in terms of size of transmitted data, transmission quality, and delay control, and is not able to solve various potential problems caused by the transmission of AI/ML models between entities.

To address at least one of the above problems, embodiments of the present application provide model transmission and reception methods and an apparatuses, in which a model transmitter segments the model and then transmits it, and a model receiver receives partial data blocks of the model based on configuration information, thus it is possible to achieve air interface transmission of large models, meet the requirements of AI/ML model transmission, and solve various potential problems caused by the transmission of AI/ML models between entities.

According to an aspect of the embodiments of the present application, there is provided with a model transmission method, including:
a network device transmitting configuration information to a terminal equipment, the configuration information being used for configuring or indicating the terminal equipment to receive partial data blocks of a model; and
the network device transmitting the partial data blocks of the model to the terminal equipment.

According to another aspect of the embodiments of the present application, there is provided with a model transmission apparatus, including:
a first transmitting unit configured to transmit configuration information to a terminal equipment, the configuration information being used for configuring or indicating the terminal equipment to receive partial data blocks of a model; and
a second transmitting unit configured to transmit the partial data blocks of the model to the terminal equipment.

According to another aspect of the embodiments of the present application, there is provided with a model reception method, including:
a terminal equipment receiving configuration information from a network device, the configuration information being used for configuring or indicating the terminal equipment to receive partial data blocks of a model; and
the terminal equipment receiving the partial data blocks of the model from the network device according to the configuration information.

According to another aspect of the embodiments of the present application, there is provided with a model reception apparatus, including:
a first receiving unit configured to receive configuration information from a network device, the configuration information being used for configuring or indicating the terminal equipment to receive partial data blocks of a model; and
a second receiving unit configured to receive the partial data blocks of the model from the network device according to the configuration information.

According to another aspect of the embodiments of the present application, there is provided with a communication system, including:
a network device configured to transmit configuration information and partial data blocks of a model to a terminal equipment; and
the terminal equipment configured to receive the configuration information from the network device, and receive the partial data blocks of the model from the network device according to the configuration information.

One of the beneficial effects of the embodiments of the present application is in: the network device segments the model and then transmits configuration information as well as partial data blocks of the model; and the terminal equipment receives the partial data blocks of the model according to the configuration information; thus it is possible to achieve air interface transmission of large models, meet the requirements of AI/ML model transmission, and solve various potential problems caused by the transmission of AI/ML models between entities.

With reference to the specification and drawings below, specific embodiments of the present application are disclosed in detail, which specify the manner in which the principle of the present application may be adopted. It should be understood that, the scope of the embodiments of the present application is not limited. Within the scope of the spirit and clause of the appended claims, the embodiments of the present application include many variations, modifications and equivalents.

The features described and/or shown for one embodiment may be used in one or more other embodiments in the same or similar manner, may be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

The included drawings are used for providing further understanding on the embodiments of the present application, constitute a portion of the description, are used for illustrating the embodiments of the present application and explain the principle of the present application together with the literary description. Obviously, the drawings described below are merely some examples of the present application, persons ordinarily skilled in the art may also obtain other drawings according to these drawings without making creative efforts. In the drawings:

FIG. 1 is a schematic diagram of the application scenario of the embodiments of the present application;

FIG. 2 is a schematic diagram of a model transmission method in the embodiments of the present application;

FIG. 3 is an example diagram of a model transmission method in the embodiments of the present application;

FIG. 4 is another example diagram of a model transmission method in the embodiments of the present application;

FIG. 5 is another example diagram of a model transmission method in the embodiments of the present application;

FIG. 6 is another schematic diagram of a model reception method in the embodiments of the present application;

FIG. 7 is a schematic diagram of a model transmission apparatus in the embodiments of the present application;

FIG. 8 is a schematic diagram of a model reception apparatus in the embodiments of the present application; and

FIG. 9 is a schematic diagram of an electronic device in the embodiments of the present application.

### EMBODIMENTS

With reference to the drawings, the foregoing and other features of the present application will become apparent through the following specification. The description and drawings specifically disclose the particular embodiments of the present application, showing part of the embodiments in which the principle of the present application may be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present application, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Long Term Evolution-Advanced (LTE-A), Wideband Code Division Multiple Access (WCDMA), High-Speed Packet Access (HSPA), etc.

In addition, the communication between the devices in the communication system may be carried out according to the communication protocol of any stage, for example, including but not being limited to 1G (generation), 2G, 2.5G, 2.75G, 3G, 4G, 4.5G and future 5G, New Radio (NR), etc., and/or other communication protocols currently known or to be developed in the future.

In the embodiments of the present application, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), an IAB donor, etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” may refer to a base station and/or its coverage area, depending on the context in which the term is used.

In the embodiments of the present application, the term “user equipment” (UE) refers, for example, to a device that is connected to the communication network through the network device and receives network services, and may also be referred to as “Terminal Equipment” (TE). The terminal equipment may be fixed or movable, and may also be called a mobile station (MS), a terminal, a user, a subscriber station (SS), an access terminal (AT), a station, etc.

The terminal equipment may include but is not limited to: a cellular phone, a personal digital assistant (PDA), a wireless modems, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

Hereinafter the scenarios of in the embodiments of the present application are illustrated by examples, but which is not limited in the present application.

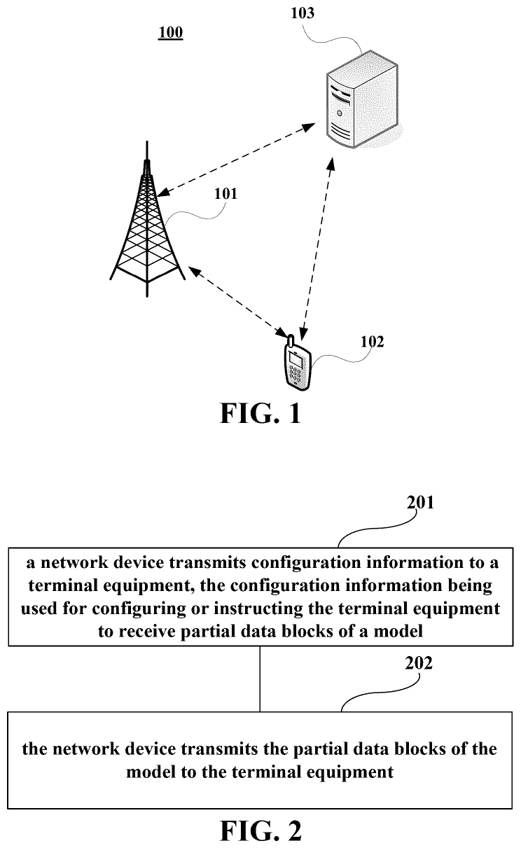

FIG. 1 is a schematic diagram of a communication system in the embodiments of the present application, illustrating the case of the terminal equipment and the network device as an example. As shown in FIG. 1, a communication system 100 may include a network device 101, a terminal equipment 102 and a location server 103. For simplicity, FIG. 1 illustrates only one terminal equipment and one network device as an example, but which is not limited in the embodiments of the present application.

In the embodiments of the present application, existing services or services that may be implemented in the future may be transmitted between the network device 101 and the terminal equipment 102. For example, these services may include, but are not limited to, enhanced Mobile Broadband (eMBB), massive Machine Type Communication (mMTC), and Ultra-Reliable and Low-Latency Communication (URLLC), and etc.

It is worth noting that FIG. 1 shows that the terminal equipment 102 is within the coverage of the network equipment 101, but which is not limited in the present application. The terminal equipment 102 may not be within the coverage of the network device 101. In addition, FIG. 1 illustrates the deployment of the location server 103 alone as an example, where an AI/ML model may be run in the location server 103 to obtain a location result; but the present application is not limited to this, and the location server 103 may be deployed in the core network, or in the network device 102 (such as a base station), or in the terminal equipment 103, which are not limited in the embodiments of the present application.

In the embodiments of the present application, a terminal equipment to be located may be referred to as a target device, and the function of the location server may be referred to as Location Management Function (LMF). LMF may refer to a network entity that locates and manages the terminal, or a location server with location and management functions may be abbreviated as LMF. The terms “LMF” and “location server” may be replaced with each other without causing confusion. For the specific content of these concepts and positioning, please refer to relevant technologies.

In the embodiments of the present application, the model transmission apparatus (also referred to as a model transmission module or a model transmission entity) is a network device (e.g., gNB), or it may also be an entity (such as LMF or AMF) of UE or a core network, or it may be a partial function or entity of any of the above devices. The model reception apparatus (also referred to as a model reception module or a model reception entity) is a UE, or it may also be an entity (such as LMF or AMF) of gNB or a core network, or it may be a partial function or entity of any of the above devices. In addition, FIG. 1 illustrates positioning as an example, but the present application is not limited to this. The model transmission scheme of the present application may be applied to any scenario using AI/ML model.

The wireless interface transmission supported in the current 3GPP protocol includes: control plane transmission and user plane transmission. A signaling radio Bearer (SRB) and a data radio bearer (DRB) correspond to the above two types of transmission, respectively. Both of the mechanisms have inherent defects when implementing AI/ML model transmission:
if SRB is configured for control plane transmission, although SRB transmitted by RRC messages has a higher transmission priority, the amount of data that may be carried by one RRC message is relatively limited. When the model is large, it needs to be transmitted by many RRC messages if SRB is used alone, and may not be received in terms of efficiency and time delay;
if DRB is configured for user plane transmission, although it may carry a large amount of data, DRB has a low transmission priority, and the transmitted content is invisible, which also has problems in terms of quality and time delay control.

Therefore, the current mechanism is not able to solve various potential problems caused by the transmission of AI/ML models between entities.

### Embodiments of First Aspect

The embodiments of the present application provide a model transmission method, which is explained from the side of a model transmission apparatus. The model transmission apparatus may be a network device (such as a base station), a terminal equipment (such as a target device, PRU or other terminals), or a location server with LMF function.

FIG. 2 is a schematic diagram of a signal transmission method in the embodiments of the present application. As shown in FIG. 2, the method includes:
201: a network device transmits configuration information to a terminal equipment, the configuration information being used for configuring or indicating the terminal equipment to receive partial data blocks of a model; and
202: the network device transmits the partial data blocks of the model to the terminal equipment.

It is worth noting that FIG. 2 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 2 above.

Accordingly, the network device segments the model and then transmits configuration information as well as partial data blocks of the model; and the terminal equipment receives the partial data blocks of the model according to the configuration information; thus it is possible to achieve air interface transmission of large models, meet the requirements of AI/ML model transmission, and solve various potential problems caused by the transmission of AI/ML models between entities.

In the embodiments of the present application, the above-mentioned partial data blocks are obtained by splitting the model into multiple mutually exclusive portions by the data transmission apparatus according to a certain method (such as segmentation), and each partial data block carries a part of the content of the above-mentioned model. After receiving these partial data blocks, the data reception apparatus may combine them according to a certain method to obtain the content of the above-mentioned model.

Without causing confusion, the terms “partial data block” and “segmentation chuck”, “segmentation part”, “transmission block”, “a part of the model”, etc. may be replaced with each other, and the terms “configuration information”, “model segmentation information”, etc. may be replaced with each other.

In some embodiments, the configuration information includes at least one of the following: an identifier of the model, an identifier of the partial data blocks of the model, the number of the partial data blocks of the model, an order of the partial data blocks of the model, or a size of the partial data blocks of the model.

For example, the configuration information may provide the order of partial data blocks (also known as segmentation chuck) by enhancing the RRC message DLDedicated MessageSegment in 3GPP protocol TS38.331. For another example, the configuration information includes the number of the partial data blocks.

For example, the upper limit of the maximum number of segmentation defined in the protocol for the domain segmentNumber-r16 INTEGER (0 . . . 4) is 4 (i.e., at most 5 segmentation chucks). The upper limit may be adjusted directly in the embodiments of the present application, and may be represented, for example, as segmentNumber-r16 INTEGER (0 . . . 63), so as to provide an appropriate number of segmentation chucks.

For another example, the upper limit may be adjusted as a configurable parameter, which may be represented, for example, as segmentNumber-r16 INTEGER (0 . . . maxNumSeg), and this parameter is defined as an optional configuration (such as having several options), or it may be determined through signaling interaction. This configuration parameter may be notified to the terminal equipment through RRC message before transmission.

In some embodiments, the configuration information includes a multidimensional sequence, the multidimensional sequence indicating a hierarchical structure among the partial data blocks of the model.

For example, a two-dimensional segmentation sequence definition may be provided to embody the hierarchical structure of the AI/ML model in a two-dimensional manner. For example, a plurality of segmentation sequences may be defined: a segmentation sequence 1, a segmentation sequence 2, . . . , a segmentation sequence N. Taking two segmentation sequences as an example, they may be in an inclusive or parallel relationship.

For example, if two segmentation sequences are in a parallel relationship, the segmentation sequence 1 may indicate the parameters corresponding to the model on different network layers, and the segmentation sequence 2 may indicate all the parameters corresponding to the model on different neurons. For another example, if two segmentation sequences are in an inclusive relationship, the segmentation sequence 1 may indicate a larger range of segmentation order, while the segmentation sequence 2 may provide the internal segmentation order of the segmentation sequence 1, and so on. It may be enhanced in a DLDedicatedMessageSegment message, so as to be applicable to a multidimensional sequence.

In some embodiments, the network device transmits a final identifier of the multidimensional sequence to the terminal equipment, the final identifier being used to indicate a last partial data block in a dimensional sequence for model reassembly by the terminal equipment.

For example, when a multidimensional sequence is used for indication, a final flag corresponding to the multidimensional sequence may be given, the final flag indicating that the currently transmitted segmentation chuck is located at the final end of the transmission sequence. After receiving the flag, the terminal equipment may perform operations such as partial model reassembly.

In some embodiments, the network device may further attach additional information about the current transmission segmentation chuck, such as a model ID, transmission block size (SIZE), etc., to the DLDedicatedMessageSegment enhancement information.

The configuration information has been schematically illustrated hereinbefore, and the present application is not limited to this. For example, the configuration information may further include model segmentation information, the model segmentation information including at least one of the following: an identifier of a data segmentation chuck or a data segmentation part, a model segmentation identifier, a model segmentation timestamp, a model segmentation rule, a model layer identifier, an input data source identifier, a model segmentation size, model segmentation statistics, or data statistics information. The present application is not limited to this, and may also be any combination of the above information, or may include other information.

In some embodiments, the data statistical information includes at least one of the following: a maximum value of the data segmentation chuck or the data segmentation part, a minimum value of the data segmentation chuck or the data segmentation part, an average value of the data segmentation chuck or the data segmentation part, a variance of the data segmentation chuck or the data segmentation part, size of each data segmentation chuck or data segmentation part, or total size of the data segmentation chuck or the data segmentation part. The present application is not limited to this, and may also be any combination of the above information, or may include other information.

In some embodiments, the model segmentation statistics include at least one of the following: a weight mean, a weight variance, a partial model content mean, and a partial model content variance. The present application is not limited to this, and may also be any combination of the above information, or may include other information.

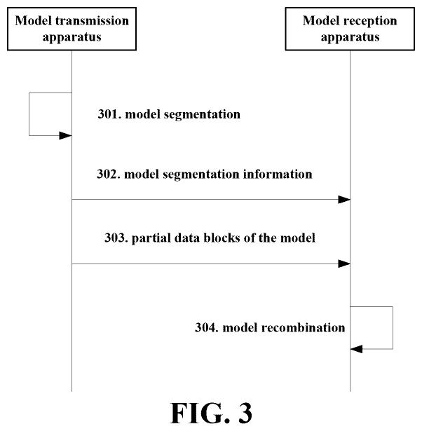

FIG. 3 is an example diagram of a model transmission method in the embodiments of the present application. For example, the model transmission apparatus is gNB and the model reception apparatus is UE.

As shown by 301 in FIG. 3, the model transmission apparatus may segment the model, generate configuration information (e.g., including model segmentation information), and partial data blocks of the model (at least part of the model). As shown by 302 in FIG. 3, the model transmission apparatus may transmit the model segmentation information to the model reception apparatus through RRC message, MAC CE, DCI/UCI, and the like. As shown by 303 in FIG. 3, the model transmission apparatus may transmit at least part of the model to the model reception apparatus. As shown by 304 in FIG. 3, the model reception apparatus reassembles the received at least part of the model based on the model segmentation information. Therefore, for example, at least part of the segmented key models in the current application may be transmitted, and thus in some cases, SRB may be used to achieve efficient transmission of the model.

It is worth noting that FIG. 3 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 3 above.

For example, 302 and 303 may be merged together (e.g. using the same message or signaling), i.e., to transmit the model segmentation information while transmitting the at least part of the model. For another example, the model segmentation information is transmitted after at least part of the model. For another example, the model segmentation information is transmitted as a portion of the at least part of the model.

In some embodiments, the partial data blocks of the model (at least part of the model) is transmitted through a signaling radio bearer (SRB) and/or a data radio bearer (DRB). For example, at least part of the model shown in 303 is transmitted through SRB, or through DRB, or through both SRB and DRB.

In some embodiments, the configuration information (model segmentation information) is transmitted through at least one of the following: a radio resource control (RRC) message, a medium access control (MAC) control element (CE), or downlink control information (DCI). The present application is not limited to this, and depending on the difference between the transmitting and receiving parties, the following signaling may also be used for transmission: uplink control information (UCI), LPP (LTE Positioning Protocol) signaling, and NRPPa (NR Positioning Protocol A) signaling. For example, the model segmentation information in 302 is transmitted through DCI.

For example, the model transmission apparatus transmits data segmentation rule information (model segmentation information) to the model reception apparatus, which is mainly used to assist the model reception apparatus in correctly reassembling the segmented model data or detecting errors in the segmented model data. Hereinafter the model segmentation information is further explained.

For example, the model transmission apparatus transmits the identification information (ID) of each model segmentation chuck to the model reception apparatus. The identifiers of the model segmentation chuck or the segmentation part may be separately represented by IE, as shown in Table 1:

TABLE 1

ModelSegmentIDList SEQUENCE (SIZE(1...maxModelSegmentation) OF
ModelSegmentID
ModelSegmentID INTEGER(0... maxModelSegmentation − 1)

In Table 1, the ModelSegmentID of the IE indicates the identifier of the segmentation chuck or the segmentation part. The present application is not limited to this, for example, the identifiers of the model segmentation chuck or the model segmentation part may be combined with other information through IE, as shown in Table 2:

TABLE 2

```
    ModelSegmentList SEQUENCE (SIZE(1...maxModelSegmentation) OF
ModelSegmentInfo
    ModelSegmentInfo SEQUENCE{
        ModelID ModelID
        ModelSegmentID INTEGER(0... maxModelSegmentation − 1)
        ModelSegmentCellID INTEGER(0,...,)
}
```

For another example, an implicit identifier may be used to transmit the model segmentation information. The model transmission apparatus transmits implicit identification information of the model segmentation chuck (part) to the model reception apparatus, and the implicit identification information is transmitted together with an implicit rule, and for example timestamp information is attached in IE, as shown in Table 3:

TABLE 3

```
    ModelSegmentList SEQUENCE (SIZE(1...maxModelSegmentation) OF
ModelSegmentInfo
    Model SegmentInfo SEQUENCE{
        ...,
        ModelSegmentTimeStap TimeStamp,
        ModelSegmentRule time_order
        ...,
    }
ModelSegmentRule ENUMERATED(time_order, layer_order, ...,)
```

IE may also be used to provide a neural network hierarchical rule, as shown in Table 4:

TABLE 4

```
    ModelSegmentList SEQUENCE (SIZE(1...maxModelSegmentation) OF
ModelSegmentInfo
    ModelSegmentInfo SEQUENCE{
        ...,
        ModelLayerID ModelLayerID,
        ModelSegmentRule layer_order,
        ...,
    }
ModelSegmentRule ENUMERATED(time_order, layer_order, ...,)
```

For another example, the data statistical information of the segmentation chuck may be transmitted. The model transmission apparatus transmits the data statistical information of the model segmentation chuck (part) to the model reception apparatus, and attaches, for example, the data size of each segmentation part in IE, and/or the total data size of all segmentation parts, and/or the weight statistical distribution of the segmentation parts (such as mean, variance, etc.), as shown in Table 5:

TABLE 5

```
    ModelSegmentList SEQUENCE (SIZE(1...maxModelSegmentation) OF
ModelSegmentInfo
    ModelSegmentInfo SEQUENCE{
        ...,
        ModelSegmentSize ModelSegmentSize,
        ModelSegmentStats SEQUENCE{
            ...,
            WeightsMean WeightsMean,
            WeightsVariance WeightsVariance,
            ...,
        ...,
}
```

The configuration information (model segmentation information) has been exemplarily illustrated hereinbefore, and the present application is not limited to this.

In some embodiments, the model transmission apparatus receives feedback information from the model reception apparatus.

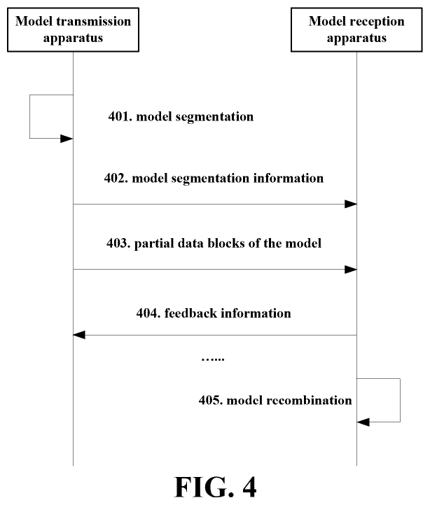

FIG. 4 is another example diagram of a model transmission method in the embodiments of the present application. For example, the model transmission apparatus is gNB and the model reception apparatus is UE.

As shown by 401 in FIG. 4, the model transmission apparatus may segment the model, generating model segmentation information and at least part of the model. As shown by 402 in FIG. 4, the model transmission apparatus may transmit the model segmentation information to the model reception apparatus through RRC message, MAC CE, DCI/UCI, and the like. As shown by 403 in FIG. 4, the model transmission apparatus may transmit at least part of the model to the model reception apparatus.

As shown by 404 in FIG. 4, alternatively, the model reception apparatus may also transmit feedback information to the model transmission apparatus, and for example, feed back that no data statistical information has been received and require retransmission, and for another example, feed back that no data block (data part) has been received, and for another example, feed back that all information has been received, and so on. As shown by 405 in FIG. 4, the model reception apparatus reassembles the received at least part of the model based on the model segmentation information. Therefore, for example, part of the segmented key models in the current application may be transmitted, and thus in some cases, SRB may be used to achieve efficient transmission of the model.

It is worth noting that FIG. 4 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 4 above.

For example, 402 and 403 may be merged together (e.g. using the same message or signaling), i.e., to transmit the model segmentation information while transmitting the at least part of the model. For another example, the model segmentation information is transmitted after at least part of the model. For another example, the model segmentation information is transmitted as a portion of the at least part of the model. For another example, information interaction may be performed for many times before 405, until all the information required for model reassembly has been obtained by the model reception apparatus. For another example, in the case of feedback transmission failure in 404, the model reassembly in 405 may be canceled.

In some embodiments, the model transmission apparatus receives assistance information for assisting in segmenting the model into partial data blocks from the model reception apparatus.

For example, the assistance information includes at least one of the following: a performance quality requirement, performance evaluation information, or priority information. The present application is not limited to this, and may also be any combination of the above information, or may include other information.

In some embodiments, the assistance information is transmitted through at least one of the following: a radio resource control (RRC) message, a medium access control (MAC) control element (CE), or uplink control information (UCI).

For example, before the model transmission apparatus segments the model, the transmitter and the receiver may perform some signaling interaction to provide assistance information for the model segmentation, so that the model transmission apparatus may better segment the model. For example, the transmitter may request the receiver to transmit the assistance information, and for another example, the receiver may also actively transmit the assistance information when the model transmission is initiated. The assistance information may be transmitted by using RRC message, MAC CE, UCI, etc.

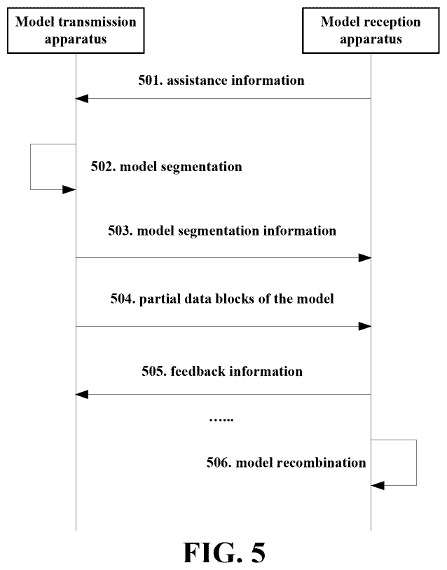

FIG. 5 is another example diagram of a model transmission method in the embodiments of the present application. For example, the model transmission apparatus is gNB and the model reception apparatus is UE.

As shown by 501 in FIG. 5, the model reception apparatus may transmit assistance information to the model transmission apparatus, and the assistance information may be transmitted based on the request of the model transmission apparatus or may be actively transmitted by the model reception apparatus. As shown by 502 in FIG. 5, the model transmission apparatus may segment the model based on the assistance information, and generate model segmentation information and at least part of the model. As shown by 503 in FIG. 5, the model transmission apparatus may transmit the model segmentation information to the model reception apparatus through RRC messages, MAC CE, DCI/UCI, and the like. As shown by 504 in FIG. 5, the model transmission apparatus may transmit at least part of the model to the model reception apparatus.

As shown by 505 in FIG. 5, alternatively, the model reception apparatus may also transmit feedback information to the model transmission apparatus, and for example, feed back that no data statistical information has been received and retransmission is required, and for another example, feed back that no data block (data part) has been received, and for another example, feed back that all information has been received, and so on. As shown by 506 in FIG. 5, the model reception apparatus reassembles the received at least part of the model based on the model segmentation information. Therefore, for example, part of the segmented key models in the current application may be transmitted, and thus in some cases, SRB may be used to achieve efficient transmission of the model.

It is worth noting that FIG. 5 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 5 above.

For example, before 501, the model transmission apparatus may transmit request information to the model reception apparatus to request the model reception apparatus to transmit the assistance information. For another example, 503 and 504 may be merged together (e.g. using the same message or signaling), i.e., to transmit the model segmentation information while transmitting the at least part of the model. For another example, the model segmentation information is transmitted after at least part of the model. For another example, the model segmentation information is transmitted as a portion of the at least part of the model. For another example, information interaction may be performed for many times before 506, until all the information required for model reassembly has been obtained by the model reception apparatus. For another example, in the case of feedback transmission failure in 505, the model reassembly in 506 may be canceled.

The information interaction has been exemplarily illustrated hereinbefore, and hereinafter the assistance information is exemplarily illustrated.

For example, the model reception apparatus transmits service quality requirements or QoS information to the model transmission apparatus as needed, wherein the service quality requirements may be specifically specified in conjunction with specific application examples, and Table 6 illustrates an example of wireless positioning application.

TABLE 6

```
ModelSegmentAdditionalInfo SEQUENCE{
        ...,
        Application_Service_Requiement Application_Service_Requiement
        ...,
    }
    Application_Service_Requiement SEQUENCE{
    ...,
    AppType ENUMERATED{CSI, BM, POS, ...},
    AppPerformanceReq AppPerformanceReq,
    AppLatencyReq AppLatencyReq,
    ...,
}
```

In some embodiments, the network device receives terminal capability information and/or model identification information transmitted by the terminal equipment, the terminal capability information and/or the model identification information being used by the network device to generate the configuration information.

In some embodiments, the network device calculates the maximum number of the partial data blocks of the model according to terminal capability information and/or the model identification information; and contains the maximum number in the configuration information to be transmitted to the terminal equipment.

For example, gNB may inquire about the storage capacity and other related information of the current UE through methods such as UE Capability. After the UE reports its capabilities as needed, gNB may obtain maxNumSeg through its own algorithm and transmit it to the UE through RRC message.

In some embodiments, the network device receives indication information of retransmitting or suspending transmission or terminating transmission transmitted by the terminal equipment.

For example, after receiving the configuration information and the partial data blocks transmitted by the network device, the terminal equipment may indicate to discard the partial data blocks according to the configuration information, or reassemble the partial data blocks and then start AI/ML inference. This AI/ML inference does not require waiting for all data blocks to be received. The terminal equipment may also request, based on the inference results, through RRC message, the network device to retransmit the partial data blocks or stop the transmission of the remaining segmentation chucks. The network device performs retransmission or terminates the transmission after receiving the message.

The above explanation is based on the example of a data transmission apparatus as the network device and a data reception apparatus as the terminal equipment. The present application is not limited to this, and the following explanation will be given by taking a data transmission apparatus as the terminal equipment and a data reception apparatus as the network device, and the same content mentioned above will be omitted.

In some embodiments, the terminal equipment receives configuration information transmitted by the network device, the configuration information being used for configuring or indicating the terminal equipment to transmit partial data blocks of a model; the terminal equipment transmits the partial data blocks of the model to the network device.

In some embodiments, the configuration information includes at least one of the following: an identifier of the model, an identifier of the partial data blocks of the model, the number of the partial data blocks of the model, an order of the partial data blocks of the model, or a size of the partial data blocks of the model.

In some embodiments, the configuration information includes a multidimensional sequence, the multidimensional sequence indicating a hierarchical structure among the partial data blocks of the model.

In some embodiments, the terminal equipment transmits a final identifier of the multidimensional sequence to the network device, the final identifier being used to indicate a last partial data block in a dimensional sequence for model reassembly by the network device.

In some embodiments, the partial data blocks of the model are transmitted through a signaling radio bearer (SRB) and/or a data radio bearer (DRB).

In some embodiments, the configuration information is transmitted through at least one of the following: a radio resource control (RRC) message, a medium access control (MAC) control element (CE), or downlink control information (DCI).

In some embodiments, the terminal equipment receives assistance information for assisting in segmenting the model into partial data blocks from the network device.

In some embodiments, the assistance information includes at least one of the following: a performance quality requirement, performance evaluation information, or priority information.

In some embodiments, the assistance information is transmitted through at least one of the following: a radio resource control (RRC) message, a medium access control (MAC) control element (CE), or uplink control information (UCI).

In some embodiments, the terminal equipment receives the feedback information from the network device.

In some embodiments, the terminal equipment performs model segmentation and generates partial data blocks of the model.

In some embodiments, the terminal equipment transmits terminal capability information and/or model identification information to the network device, the terminal capability information and/or the model identification information being used by the network device to generate the configuration information.

In some embodiments, the terminal equipment calculates the maximum number of the partial data blocks of the model; and transmits the maximum number to the network device.

In some embodiments, the terminal equipment receives indication information of retransmitting or suspending transmission or terminating transmission transmitted by the network device.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, the network device transmits configuration information as well as partial data blocks of the model; and the terminal equipment receives the partial data blocks of the model according to the configuration information; thus it is possible to achieve air interface transmission of large models, meet the requirements of AI/ML model transmission, and solve various potential problems caused by the transmission of AI/ML models between entities.

### An Embodiments of Second Aspect

The embodiments of the present application provide a model reception method, which is explained from the side of a model reception apparatus. The embodiments of the second aspect correspond to that of the first aspect, and the same content will not be repeated.

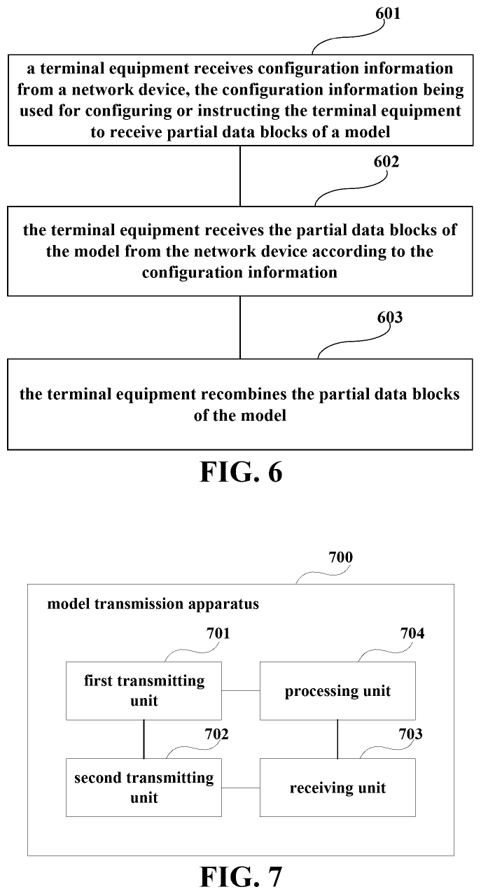

FIG. 6 is another schematic diagram of a model reception method in the embodiments of the present application. As shown in FIG. 6, the method includes:
601: a terminal equipment receives configuration information from a network device, the configuration information being used for configuring or indicating the terminal equipment to receive partial data blocks of a model; and
602: the terminal equipment receives the partial data blocks of the model from the network device according to the configuration information.

In some embodiments, as shown in FIG. 6, the method may further include:
603: the terminal equipment reassembles the partial data blocks of the model.

It is worth noting that FIG. 6 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 6 above.

In some embodiments, the configuration information includes at least one of the following: an identifier of the model, an identifier of the partial data blocks of the model, the number of the partial data blocks of the model, an order of the partial data blocks of the model, or a size of the partial data blocks of the model.

In some embodiments, the configuration information includes a multidimensional sequence, the multidimensional sequence indicating a hierarchical structure among the partial data blocks of the model.

In some embodiments, the terminal equipment receives a final identifier of the multidimensional sequence to the terminal equipment, the final identifier being used to indicate a last partial data block in a dimensional sequence for model reassembly by the terminal equipment.

In some embodiments, the partial data blocks of the model are transmitted through a signaling radio bearer (SRB) and/or a data radio bearer (DRB).

In some embodiments, the configuration information is transmitted through at least one of the following: a radio resource control (RRC) message, a medium access control (MAC) control element (CE), or downlink control information (DCI).

In some embodiments, the terminal equipment transmits assistance information for assisting in segmenting the model into partial data blocks to the network device.

In some embodiments, the assistance information includes at least one of the following: a performance quality requirement, performance evaluation information, or priority information.

In some embodiments, the assistance information is transmitted through at least one of the following: a radio resource control (RRC) message, a medium access control (MAC) control element (CE), or uplink control information (UCI).

In some embodiments, the terminal equipment transmits the feedback information to the network device.

In some embodiments, the terminal equipment transmits terminal capability information and/or model identification information to the network device, the terminal capability information and/or the model identification information being used by the network device to generate the configuration information.

In some embodiments, the terminal equipment receives a maximum number of the partial data blocks of the model, wherein the network device calculates the maximum number of the partial data blocks of the model according to terminal capability information and/or the model identification information.

In some embodiments, the terminal equipment transmits indication information of retransmitting or suspending transmission or terminating transmission to the network device.

The above explanation is based on the example of a data transmission apparatus as the network device and a data reception apparatus as the terminal equipment. The present application is not limited to this, and the following explanation will be given by taking a data transmission apparatus as the terminal equipment and a data reception apparatus as the network device, and the same content mentioned above will be omitted.

In some embodiments, the network device transmits configuration information to the terminal equipment, the configuration information being used for configuring or indicating the terminal equipment to transmit partial data blocks of the model; and the network device receives the partial data blocks of the model from the terminal equipment.

In some embodiments, the network device reassembles the partial data blocks of the model.

In some embodiments, the configuration information includes at least one of the following: an identifier of the model, an identifier of the partial data blocks of the model, the number of the partial data blocks of the model, an order of the partial data blocks of the model, or a size of the partial data blocks of the model.

In some embodiments, the configuration information includes a multidimensional sequence, the multidimensional sequence indicating a hierarchical structure among the partial data blocks of the model.

In some embodiments, the network device receives a final identifier of the multidimensional sequence to the terminal equipment, the final identifier being used to indicate a last partial data block in a dimensional sequence for model reassembly by the network device.

In some embodiments, the partial data blocks of the model are transmitted through a signaling radio bearer (SRB) and/or a data radio bearer (DRB).

In some embodiments, the configuration information is transmitted through at least one of the following: a radio resource control (RRC) message, a medium access control (MAC) control element (CE), or downlink control information (DCI).

In some embodiments, the network device transmits assistance information for assisting in segmenting the model into partial data blocks to the terminal equipment.

In some embodiments, the assistance information includes at least one of the following: a performance quality requirement, performance evaluation information, or priority information.

In some embodiments, the assistance information is transmitted through at least one of the following: a radio resource control (RRC) message, a medium access control (MAC) control element (CE), or uplink control information (UCI).

In some embodiments, the network device transmits the feedback information to the terminal equipment.

In some embodiments, the network device receives terminal capability information and/or model identification information transmitted by the terminal equipment, the terminal capability information and/or the model identification information being used by the network device to generate the configuration information.

In some embodiments, the network device receives a maximum number of the partial data blocks of the model; wherein the terminal equipment calculates the maximum number of the partial data blocks of the model.

In some embodiments, the network device transmits indication information of retransmitting or suspending transmission or terminating transmission to the terminal equipment.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, the network device transmits configuration information as well as partial data blocks of the model; and the terminal equipment receives the partial data blocks of the model according to the configuration information; thus it is possible to achieve air interface transmission of large models, meet the requirements of AI/ML model transmission, and solve various potential problems caused by the transmission of AI/ML models between entities.

### An Embodiments of Third Aspect

The embodiments of the present application provide a model transmission apparatus. Since the function of the model transmission apparatus to solve the problem is the same as the method described in the embodiments of the first aspect, the specific implementation thereof may be realized referring to the embodiments of the first aspect, and the same contents will not be repeated.

FIG. 7 is a schematic diagram of a model transmission apparatus in the embodiments of the present application. As shown in FIG. 7, a model transmission apparatus 700 includes:
a first transmitting unit 701 configured to transmit configuration information to a terminal equipment, the configuration information being used for configuring or indicating the terminal equipment to receive partial data blocks of a model; and
a second transmitting unit 702 configured to transmit the partial data blocks of the model to the terminal equipment.

It is worth noting that FIG. 7 above only schematically illustrates the embodiments of the present application, but the present application is not limited to this. For example, some other modules or components may be appropriately added, or some modules or components thereof may be reduced. Those skilled in the art may make appropriate variations in accordance with the above contents, and which is not limited to the disclosure of FIG. 7 above.

In some embodiments, the configuration information includes at least one of the following: an identifier of the model, an identifier of the partial data blocks of the model, the number of the partial data blocks of the model, an order of the partial data blocks of the model, or a size of the partial data blocks of the model.

In some embodiments, the configuration information includes a multidimensional sequence, the multidimensional sequence indicating a hierarchical structure among the partial data blocks of the model.

In some embodiments, the second transmitting unit 702 further transmits a final identifier of the multidimensional sequence to the terminal equipment, the final identifier being used to indicate a last partial data block in a dimensional sequence for model reassembly by the terminal equipment.

In some embodiments, the partial data blocks of the model are transmitted through a signaling radio bearer (SRB) and/or a data radio bearer (DRB);
and the configuration information is transmitted through at least one of the following: a radio resource control (RRC) message, a medium access control (MAC) control element (CE), or downlink control information (DCI).

In some embodiments, as shown in FIG. 7, the model transmission apparatus 700 may further include:
a receiving unit 703 configured to receive assistance information for assisting segmenting the model into partial data blocks from the terminal equipment.

In some embodiments, the assistance information includes at least one of the following: a performance quality requirement, performance evaluation information, or priority information. In some embodiments, the assistance information is transmitted through at least one of the following: a radio resource control (RRC) message, a medium access control (MAC) control element (CE), or uplink control information (UCI).

In some embodiments, the receiving unit 703 further receives feedback information from the terminal equipment.

In some embodiments, as shown in FIG. 7, the model transmission apparatus 700 may further include:
a processing unit 704 configured to perform model segmentation and generate the configuration information and the partial data blocks of the model.

In some embodiments, the processing unit 704 further calculates a maximum number of the partial data blocks of the model according to terminal capability information and/or model identification information, and contains the maximum number in the configuration information.

In some embodiments, the receiving unit 703 further receives terminal capability information and/or model identification information transmitted by the terminal equipment, the terminal capability information and/or the model identification information being used by the network device to generate the configuration information.

In some embodiments, the receiving unit 703 further receives indication information of retransmitting or suspending transmission or terminating transmission transmitted by the terminal equipment.

In addition, for the sake of simplicity, FIG. 7 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, the network device transmits configuration information as well as partial data blocks of the model; and the terminal equipment receives the partial data blocks of the model according to the configuration information; thus it is possible to achieve air interface transmission of large models, meet the requirements of AI/ML model transmission, and solve various potential problems caused by the transmission of AI/ML models between entities.

### An Embodiments of Fourth Aspect

The embodiments of the present application provide a model reception apparatus. Since the function of the model reception apparatus to solve the problem is the same as the method described in the embodiments of the second aspect, the specific implementation thereof may be realized referring to the embodiments of the first and second aspects, and the same contents will not be repeated.

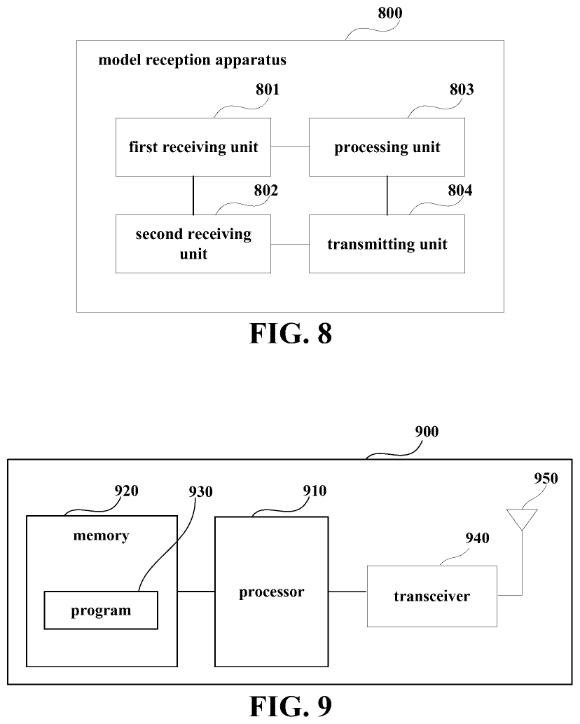

FIG. 8 is a schematic diagram of a model reception apparatus in the embodiments of the present application. As shown in FIG. 8, a model reception apparatus 800 includes:
a first receiving unit 801 configured to receive configuration information from a network device, the configuration information being used for configuring or indicating the terminal equipment to receive partial data blocks of a model; and
a second receiving unit 802 configured to receive the partial data blocks of the model from the network device according to the configuration information.

In some embodiments, as shown in FIG. 8, the model reception apparatus 800 may further include:
a processing unit 803 configured to reassemble the partial data blocks of the model.

It is worth noting that FIG. 8 above only schematically illustrates the embodiments of the present application, but the present application is not limited to this. For example, some other modules or components may be appropriately added, or some modules or components thereof may be reduced. Those skilled in the art may make appropriate variations in accordance with the above contents, and which is not limited to the disclosure of FIG. 8 above.

In some embodiments, as shown in FIG. 8, the model reception apparatus 800 may further include:
a transmitting unit 804 configured to transmit assistance information for assisting in segmenting the model into partial data blocks to the network device. In some embodiments, the assistance information includes at least one of the following: a performance quality requirement, performance evaluation information, or priority information.

In some embodiments, the assistance information is transmitted through at least one of the following: a radio resource control (RRC) message, a medium access control (MAC) control element (CE), or uplink control information (UCI).

In some embodiments, the transmitting unit 804 further transmits the feedback information to the network device.

In some embodiments, the transmitting unit 804 further transmits terminal capability information and/or model identification information to the network device, the terminal capability information and/or the model identification information being used by the network device to generate the configuration information.

In some embodiments, the second receiving unit 802 further receives a maximum number of the partial data blocks of the model, wherein the network device calculates the maximum number of the partial data blocks of the model according to terminal capability information and/or the model identification information.

In some embodiments, the transmitting unit 804 further transmits indication information of retransmitting or suspending transmission or terminating transmission to the network device.

In addition, for the sake of simplicity, FIG. 8 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, the network device transmits configuration information as well as partial data blocks of the model; and the terminal equipment receives the partial data blocks of the model according to the configuration information; thus it is possible to achieve air interface transmission of large models, meet the requirements of AI/ML model transmission, and solve various potential problems caused by the transmission of AI/ML models between entities.

### An Embodiments of Fifth Aspect

The embodiments of the present application provide a communication system. FIG. 1 is a schematic diagram of the communication system of the embodiments of the present application. As shown in FIG. 1, the communication system 100 includes a network device 101, a terminal equipment 102 and a location server 103. For the sake of simplicity, FIG. 1 gives exemplary illustration by taking only one network device and one terminal equipment as an example, but the embodiments of the present application are not limited to this.

In some embodiments, the communication system includes:
a network device configured to transmit configuration information and partial data blocks of a model to a terminal equipment; and
the terminal equipment configured to receive the configuration information from the network device, and receive the partial data blocks of the model from the network device according to the configuration information.

The embodiments of the present application further provide an electronic device. The electronic device is, for example, a model transmission apparatus or a model reception apparatus described above.

FIG. 9 is a schematic diagram of composition of the electronic device in the embodiments of the present application. As shown in FIG. 9, an electronic device 900 may include a processor 910 (such as a central processing unit (CPU)) and a memory 920; the memory 920 is coupled to the processor 910. The memory 920 may store various data and also may store the information processing program 930, and the program 930 is executed under the control of the processor 910.

For example, the processor 910 may be configured to execute the program to implement the model transmission method as described in the embodiments of the first aspect. For example, the processor 910 may be configured to perform the following controls of: transmitting configuration information to a terminal equipment, the configuration information being used for configuring or indicating the terminal equipment to receive partial data blocks of a model; and transmitting the partial data blocks of the model to the terminal equipment.

For another example, the processor 910 may be configured to execute the program to implement the model reception method as described in the embodiments of the second aspect. For example, the processor 910 may be configured to perform the following controls of: receiving configuration information from a network device, the configuration information being used for configuring or indicating the terminal equipment to receive partial data blocks of a model; and receiving the partial data blocks of the model from the network device according to the configuration information.

In addition, as shown in FIG. 9, the electronic device 900 may further include: a transceiver 940 and an antenna 950, etc.; wherein the functions of the above components are similar to the related art, and will not be repeated here. It is worth noting that the electronic device 900 is not necessarily required to include all of the components shown in FIG. 9; in addition, the electronic device 900 may further include components not shown in FIG. 9, with reference to the related art.

The embodiments of the present application further provide a computer readable program which, when being executed in a model transmission apparatus, causes a computer to execute the model transmission method described in the embodiments of the first aspect in the model transmission apparatus.

The embodiments of the present application further provide a storage medium storing a computer readable program which causes the computer to execute the model transmission method described in the embodiments of the first aspect in the model transmission apparatus.

The embodiments of the present application further provide a computer readable program which, when being executed in a model reception apparatus, causes a computer to execute the model reception method described in the embodiments of the second aspect in the model reception apparatus.

The embodiments of the present application further provide a storage medium storing a computer readable program which causes the computer to execute the model reception method described in the embodiments of the second aspect in the model reception apparatus.

The above devices and methods of the present application may be implemented by hardware or by hardware combined with software. The present application relates to a computer readable program which, when being executed by a logic unit, enables the logic unit to implement the devices or components mentioned above, or enables the logic unit to implement the methods or steps described above. The logic unit is, for example, a field programmable logic unit, a microprocessor, a processor used in the computer, etc. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules may correspond to the steps shown in the drawings respectively. These hardware modules may be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium may be coupled to a processor so that the processor may read information from the storage medium and write information to the storage medium; or the storage medium may be a constituent part of the processor. The processor and the storage medium may be located in the ASIC. The software module may be stored in the memory of the mobile terminal or in a memory card that may be inserted into the mobile terminal. For example, if a device (such as a mobile terminal) uses a large-capacity MEGA-SIM card or a large-capacity flash memory device, the software module may be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art may make various variations and modifications to the present application according to spirit and principle of the application, and these variations and modifications should also be within the scope of the present application.

With respect to the above-mentioned embodiments disclosed in the embodiments, the following supplements are further disclosed:
1. A model transmission method, including:
a network device transmitting configuration information to a terminal equipment, the configuration information being used for configuring or indicating the terminal equipment to receive partial data blocks of a model; and
the network device transmitting the partial data blocks of the model to the terminal equipment.
2. The method according to the supplement 1, wherein the configuration information includes at least one of the following: an identifier of the model, an identifier of the partial data blocks of the model, the number of the partial data blocks of the model, an order of the partial data blocks of the model, or a size of the partial data blocks of the model.
3. The method according to the supplement 1, wherein the configuration information includes a multidimensional sequence, the multidimensional sequence indicating a hierarchical structure among the partial data blocks of the model.
4. The method according to the supplement 3, wherein the method further includes:
the network device transmitting a final identifier of the multidimensional sequence to the terminal equipment, the final identifier being used to indicate a last partial data block in a dimensional sequence for model reassembly by the terminal equipment.
5. The method according to any one of the supplements 1 to 4, wherein the partial data blocks of the model are transmitted through a signaling radio bearer (SRB) and/or a data radio bearer (DRB).
6. The method according to any one of the supplements 1 to 5, wherein the configuration information is transmitted through at least one of the following: a radio resource control (RRC) message, a medium access control (MAC) control element (CE), or downlink control information (DCI).
7. The method according to any one of the supplements 1 to 6, wherein the method further includes:
the terminal equipment receiving assistance information for assisting in segmenting the model into partial data blocks from the network device.
8. The method according to the supplement 7, wherein the assistance information includes at least one of the following: a performance quality requirement, performance evaluation information, or priority information.
9. The method according to the supplement 7, wherein the assistance information is transmitted through at least one of the following: a radio resource control (RRC) message, a medium access control (MAC) control element (CE), or uplink control information (UCI).
10. The method according to any one of the supplements 1 to 9, wherein the method further includes:
the terminal equipment receiving the feedback information from the network device.
11. The method according to any one of the supplements 1 to 10, wherein the method further includes:
the network device performing model segmentation and generating the configuration information and the partial data blocks of the model.
12. The method according to any one of the supplements 1 to 11, wherein the method further includes:
the network device receiving terminal capability information and/or model identification information transmitted by the terminal equipment, the terminal capability information and/or the model identification information being used by the network device to generate the configuration information.
13. The method according to the supplement 12, wherein the method further includes:
the network device calculating the maximum number of the partial data blocks of the model according to terminal capability information and/or the model identification information; and containing the maximum number in the configuration information to be transmitted to the terminal equipment.
14. The method according to any one of the supplements 1 to 13, wherein the method further includes:
the network device receiving indication information of retransmitting or suspending transmission or terminating transmission transmitted by the terminal equipment.
15. A model reception method including:
a terminal equipment receiving configuration information from a network device, the configuration information being used for configuring or indicating the terminal equipment to receive partial data blocks of a model; and
the terminal equipment receiving the partial data blocks of the model from the network device according to the configuration information.
16. The method according to the supplement 15, wherein the method further includes:
the terminal equipment recombining the partial data blocks of the model.
17. The method according to the supplement 15, wherein the configuration information includes at least one of the following: an identifier of the model, an identifier of the partial data blocks of the model, the number of the partial data blocks of the model, an order of the partial data blocks of the model, or a size of the partial data blocks of the model.
18. The method according to the supplement 15, wherein the configuration information includes a multidimensional sequence, the multidimensional sequence indicating a hierarchical structure among the partial data blocks of the model.
19. The method according to the supplement 18, wherein the method further includes:
the terminal equipment receiving a final identifier of the multidimensional sequence to the terminal equipment, the final identifier being used to indicate a last partial data block in a dimensional sequence for model reassembly by the terminal equipment.
20. The method according to any one of the supplements 15 to 19, wherein the partial data blocks of the model are transmitted through a signaling radio bearer (SRB) and/or a data radio bearer (DRB).
21. The method according to any one of the supplements 15 to 20, wherein the configuration information is transmitted through at least one of the following: a radio resource control (RRC) message, a medium access control (MAC) control element (CE), or downlink control information (DCI).
22. The method according to any one of the supplements 15 to 21, wherein the method further includes:
the terminal equipment transmitting assistance information for assisting in segmenting the model into partial data blocks to the network device.
23. The method according to the supplement 22, wherein the assistance information includes at least one of the following: a performance quality requirement, performance evaluation information, or priority information.
24. The method according to the supplement 22, wherein the assistance information is transmitted through at least one of the following: a radio resource control (RRC) message, a medium access control (MAC) control element (CE), or uplink control information (UCI).
25. The method according to any one of the supplements 15 to 24, wherein the method further includes:
the terminal equipment transmitting the feedback information to the network device.
26. The method according to any one of the supplements 15 to 25, wherein the method further includes:
the terminal equipment transmitting terminal capability information and/or model identification information to the network device, the terminal capability information and/or the model identification information being used by the network device to generate the configuration information.
27. The method according to the supplement 26, wherein the method further includes:
the terminal equipment receiving a maximum number of the partial data blocks of the model, wherein the network device calculates the maximum number of the partial data blocks of the model according to terminal capability information and/or the model identification information.
28. The method according to any one of the supplements 15 to 27, wherein the method further includes:
the terminal equipment transmitting indication information of retransmitting or suspending transmission or terminating transmission to the network device.
29. A network device including a memory storing a computer program and a processor configured to execute the computer program to implement the model transmission method according to any one of the supplements 1 to 14.
30. A terminal equipment including a memory storing a computer program and a processor configured to execute the computer program to implement the model reception method according to any one of the supplements 15 to 28.
31. A model transmission method, including:
the terminal equipment receiving configuration information transmitted by the network device, the configuration information being used for configuring or indicating the terminal equipment to transmit partial data blocks of a model; and
the terminal equipment transmitting the partial data blocks of the model to the network device.
32. The method according to the supplement 31,wherein the configuration information includes at least one of the following: an identifier of the model, an identifier of the partial data blocks of the model, the number of the partial data blocks of the model, an order of the partial data blocks of the model, or a size of the partial data blocks of the model.
33. The method according to the supplement 31, wherein the configuration information includes a multidimensional sequence, the multidimensional sequence indicating a hierarchical structure among the partial data blocks of the model.
34. The method according to the supplement 33, wherein the method further includes:
the terminal equipment transmitting a final identifier of the multidimensional sequence to the network device, the final identifier being used to indicate a last partial data block in a dimensional sequence for model reassembly by the network device.
35. The method according to any one of the supplements 31 to 34,wherein the partial data blocks of the model are transmitted through a signaling radio bearer (SRB) and/or a data radio bearer (DRB).
36. The method according to any one of the supplements 31 to 35, wherein the configuration information is transmitted through at least one of the following: a radio resource control (RRC) message, a medium access control (MAC) control element (CE), or downlink control information (DCI).
37. The method according to any one of the supplements 31 to 36, wherein the method further includes:
the terminal equipment receiving assistance information for assisting in segmenting the model into partial data blocks from the network device.
38. The method according to the supplement 37, wherein the assistance information includes at least one of the following: a performance quality requirement, performance evaluation information, or priority information.
39. The method according to the supplement 37, wherein the assistance information is transmitted through at least one of the following: a radio resource control (RRC) message, a medium access control (MAC) control element (CE), or uplink control information (UCI).
40. The method according to any one of the supplements 31 to 39, wherein the method further includes:
the terminal equipment receiving the feedback information from the network device.
41. The method according to any one of the supplements 31 to 40, wherein the method further includes:
the terminal equipment performing model segmentation and generating partial data blocks of the model.
42. The method according to any one of the supplements 31 to 41, wherein the method further includes:
the terminal equipment transmitting terminal capability information and/or model identification information to the network device, the terminal capability information and/or the model identification information being used by the network device to generate the configuration information.
43. The method according to the supplement 42, wherein the method further includes:
the terminal equipment calculating the maximum number of the partial data blocks of the model; and transmitting the maximum number to the network device.
44. The method according to any one of the supplements 31 to 43, wherein the method further includes:
the terminal equipment receiving indication information of retransmitting or suspending transmission or terminating transmission transmitted by the network device.
45. A model reception method including:
the network device transmitting configuration information to the terminal equipment, the configuration information being used for configuring or indicating the terminal equipment to transmit partial data blocks of the model; and
the network device receiving the partial data blocks of the model from the terminal equipment.
46. The method according to the supplement 45, wherein the method further includes:
the network device recombining the partial data blocks of the model.
47. The method according to the supplement 45, wherein the configuration information includes at least one of the following: an identifier of the model, an identifier of the partial data blocks of the model, the number of the partial data blocks of the model, an order of the partial data blocks of the model, or a size of the partial data blocks of the model.
48. The method according to the supplement 45, wherein the configuration information includes a multidimensional sequence, the multidimensional sequence indicating a hierarchical structure among the partial data blocks of the model.
49. The method according to the supplement 48, wherein the method further includes:
the network device receiving a final identifier of the multidimensional sequence to the terminal equipment, the final identifier being used to indicate a last partial data block in a dimensional sequence for model reassembly by the network device.
50. The method according to any one of the supplements 45 to 49, wherein the partial data blocks of the model are transmitted through a signaling radio bearer (SRB) and/or a data radio bearer (DRB).
51. The method according to any one of the supplements 45 to 50, wherein the configuration information is transmitted through at least one of the following: a radio resource control (RRC) message, a medium access control (MAC) control element (CE), or downlink control information (DCI).
52. The method according to any one of the supplements 45 to 51, wherein the method further includes:
the network device transmitting assistance information for assisting in segmenting the model into partial data blocks to the terminal equipment.
53. The method according to the supplement 52, wherein the assistance information includes at least one of the following: a performance quality requirement, performance evaluation information, or priority information.
54. The method according to the supplement 52, wherein the assistance information is transmitted through at least one of the following: a radio resource control (RRC) message, a medium access control (MAC) control element (CE), or uplink control information (UCI).
55. The method according to any one of the supplements 45 to 54, wherein the method further includes:
the network device transmitting the feedback information to the terminal equipment.
56. The method according to any one of the supplements 45 to 55, wherein the method further includes:
the network device receiving terminal capability information and/or model identification information transmitted by the terminal equipment, the terminal capability information and/or the model identification information being used by the network device to generate the configuration information.
57. The method according to the supplement 56, wherein the method further includes:
the network device receiving a maximum number of the partial data blocks of the model; wherein the terminal equipment calculates the maximum number of the partial data blocks of the model.
58. The method according to any one of the supplements 45 to 57, wherein the method further includes:
the network device transmitting indication information of retransmitting or suspending transmission or terminating transmission to the terminal equipment.
59. A terminal equipment including a memory storing a computer program and a processor configured to execute the computer program to implement the model transmission method according to any one of the supplements 31 to 44.
60. A network device including a memory storing a computer program and a processor configured to execute the computer program to implement the model reception method according to any one of the supplements 45 to 58.

What is claimed is:

1. A model transmission apparatus, configured in a network device, the apparatus comprising:
a first transmitter configured to transmit configuration information to a terminal equipment, the configuration information being used for configuring or indicating the terminal equipment to receive partial data blocks of a model; and
a second transmitter configured to transmit the partial data blocks of the model to the terminal equipment.

2. The apparatus according to claim 1, wherein the configuration information comprises at least one of the following: an identifier of the model, an identifier of the partial data blocks of the model, the number of the partial data blocks of the model, an order of the partial data blocks of the model, or a size of the partial data blocks of the model.

3. The apparatus according to claim 1, wherein the configuration information comprises a multidimensional sequence, the multidimensional sequence indicating a hierarchical structure among the partial data blocks of the model.

4. The apparatus according to claim 3, wherein the second transmitter further transmits a final identifier of the multidimensional sequence to the terminal equipment, the final identifier being used to indicate a last partial data block in a dimensional sequence for model reassembly by the terminal equipment.

5. The apparatus according to claim 1, wherein the partial data blocks of the model are transmitted via a signaling radio bearer and/or a data radio bearer;
and the configuration information is transmitted via at least one of the following: a radio resource control message, a medium access control control element, or downlink control information.

6. The apparatus according to claim 1, wherein the apparatus further comprises:
a receiver configured to receive assistance information for assisting segmenting the model into partial data blocks from the terminal equipment.

7. The apparatus according to claim 6, wherein the assistance information comprises at least one of the following: a performance quality requirement, performance evaluation information, or priority information.

8. The apparatus according to claim 6, wherein the assistance information is transmitted via at least one of the following: a radio resource control message, a medium access control control element, or uplink control information.

9. The apparatus according to claim 6, wherein the receiver further receives feedback information from the terminal equipment.

10. The apparatus according to claim 1, wherein the apparatus further comprises:
processor circuity configured to perform model segmentation and generate the configuration information and the partial data blocks of the model.

11. The apparatus according to claim 10, wherein the processor circuity further calculates a maximum number of the partial data blocks of the model according to terminal capability information and/or model identification information, and contains the maximum number in the configuration information.

12. The apparatus according to claim 6, wherein the receiver further receives terminal capability information and/or model identification information transmitted by the terminal equipment, the terminal capability information and/or the model identification information being used by the network device to generate the configuration information.

13. The apparatus according to claim 6, wherein the receiver further receives indication information transmitted by the terminal equipment for retransmitting or suspending or terminating transmission.

14. A model reception apparatus, configured in a terminal equipment, the apparatus comprising:
a first receiver configured to receive configuration information from a network device, the configuration information being used for configuring or indicating the terminal equipment to receive partial data blocks of a model; and
a second receiver configured to receive the partial data blocks of the model from the network device according to the configuration information.

15. The apparatus according to claim 14, wherein the apparatus further comprises:
a processor circuity configured to reassemble the partial data blocks of the model.

16. The apparatus according to claim 14, wherein the apparatus further comprises:
a transmitter configured to transmit assistance information for assisting segmenting the model to the network device.

17. The apparatus according to claim 16, wherein the transmitter further transmits terminal capability information and/or model identification information to the network device, the terminal capability information and/or the model identification information being used by the network device to generate the configuration information.

18. The apparatus according to claim 14, wherein the second receiver further receives a maximum number of the partial data blocks of the model, wherein the network device calculates the maximum number of the partial data blocks of the model according to terminal capability information and/or the model identification information.

19. The apparatus according to claim 16, wherein the transmitter further transmits indication information to the network device for retransmitting or suspending or terminating transmission.

20. A communication system, comprising:
a network device configured to transmit configuration information and partial data blocks of a model to a terminal equipment; and
the terminal equipment configured to receive the configuration information from the network device, and receive the partial data blocks of the model from the network device according to the configuration information.
